(19) United States
(12) Patent Application Publication
(10) Pub. No.: US 2013/0185181 A1
(43) Pub. Date: Jul. 18, 2013

(54) DEVICE AND METHOD FOR ATM MULTI-APPLICATION

(71) Applicants: Mauricio Fidelis Rodrigues, JR., São Paulo (BR); Romeo Carnevalli Neto, São Paulo (BR); Mauricio Cosme Cohen Tucci, São Bernardo do Campo (BR); Amílcar Rosa Pereira, Barueri (BR); Luis Ricardo Machado Bueno, São Paulo (BR); Carlos Issao Kuribara, Santana do Parnaiba (BR)

(72) Inventors: Mauricio Fidelis Rodrigues, JR., São Paulo (BR); Romeo Carnevalli Neto, São Paulo (BR); Mauricio Cosme Cohen Tucci, São Bernardo do Campo (BR); Amílcar Rosa Pereira, Barueri (BR); Luis Ricardo Machado Bueno, São Paulo (BR); Carlos Issao Kuribara, Santana do Parnaiba (BR)

(73) Assignee: TECNOLOGIA BANCARIA S.A., Barueri (BR)

(21) Appl. No.: 13/551,727

(22) Filed: Jul. 18, 2012

(30) Foreign Application Priority Data
Jul. 20, 2011 (BR) PI 1103612-5

(51) Int. Cl. G06Q 20/10

(52) U.S. Cl. CPC G06Q 20/1085
USPC 705/35

(57) ABSTRACT

“DEVICE AND METHOD FOR ATM MULTI-APPLICATION”, wherein the present patent application has as object to provide a companionship solution of “Property application” with “Client applications” from other Financial Institutions and provides a simplified model, wherein monitoring and operation are still under responsibility of a same owner, having multiplicity only of “Client Modules”, i.e., “Property+Other Institutions”.

### FIELD OF THE INVENTION

The present application relates to a “DEVICE AND METHOD FOR ATM MULTI-APPLICATION” which has as object to provide a companionship solution of property application with client applications from other institutions. The object is to provide a simplified model, wherein monitoring and operation (module Operator) are still under responsibility of TecBan modules, having multiplicity only of client modules (TecBan+other institutions).

### STATE OF THE ART

TecBan ATMs (automatic teller machines) are currently provided with a single application to capture client transactions, which can be configured to function as a company's equipment (Banco24Horas™) or other financial institutions' equipment, in a so-called “ATM Manager” modality, so there is a logical subdivision in application among “Client Modules”, “Operator” and “Monitoring Agent”, which by using a common interface in devices, XFS, allows such system to be hosted in ATMs by any manufacturer, as long as the manufacturer provides XFS implementation for its devices.

### OBJECTIVES

This patent application provides a device and method that allow the coexistence of the “Property application” and “Client applications” of other Financial Institutions, and provides a simplified model, wherein monitoring and operation are still under responsibility of a same Owner, having multiplicity only of “Client Modules”, i.e., “property+other institutions”.

For better understanding the present patent application, the following description is set forth, accompanied by an annexed drawing, wherein it is exemplified in a non-limitative form, the following:

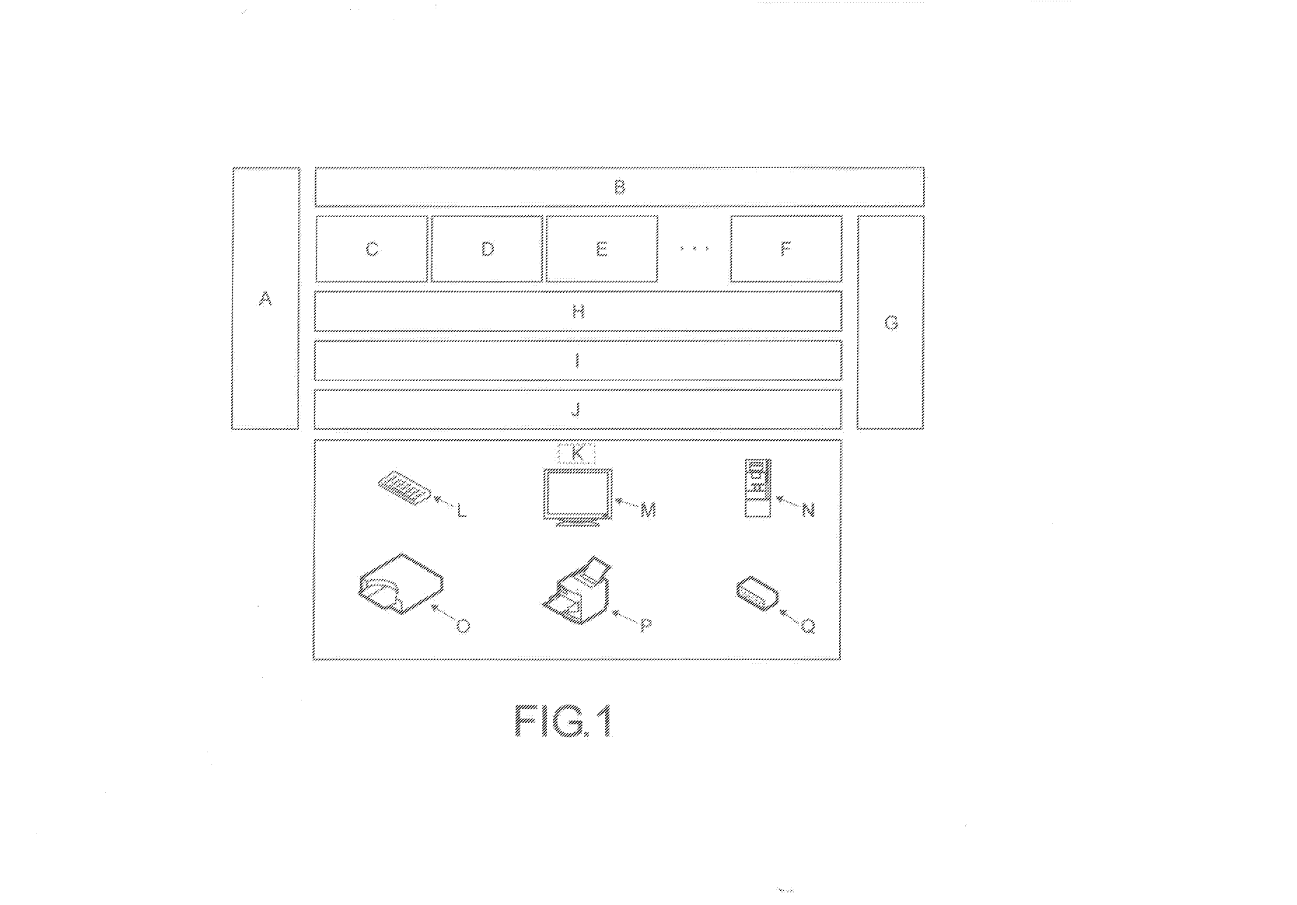

FIG. 1 illustrates the proposed method showing Multiple Client Applications.

### DESCRIPTIVE REPORT

The present patent application provides the integration of “Client Modules” from other financial institutions into a same ATM (automatic teller machine).

Modules responsible for operating and monitoring equipment are unique.

“MAM Controller” (application orchestrator) is the module responsible for managing and actuating various “Client applications” and “Operator Module” (even though it is foreseen for client applications, other third-party modules can be added, as necessary). In a user's entry, via magnetic card, chip, touch-screen, remote operation via network or any other access interface, the “MAM Controller” will identify which application must be actuated among known applications, besides monitoring the completion of each session, and then release the equipment to be used by next users.

The present patent application provides that adjustments should be made so as to actuate them from “Application orchestrator”; however, “Client applications” can also be connected to market “frameworks”, wherein various “frameworks” are able to share a same ATM.

ATM operation must be performed through “MAM Manager” (Operator Module) and, depending on equipment's manufacturer; a test module can be eventually actuated by the manufacturer. The use of operation modules used in other Financial Institutions is not foreseen.

“MAM Manager” will offer all functionalities necessary for equipment configuration, tests, diagnoses, maintenance and supply.

TecBan's “MAM Agent”, will be the only component for ATM monitoring. So, the Financial Institution does not need to have concerns regarding this type of solution.

Monitoring will provide “Operator Module” (MAM Manager) with information regarding operations, multiple client modules (information regarding transactions), and ATM devices.

Device access and control managers will define the form of accessing and controlling ATM devices, which may vary depending on the solution applied by each “Client Application”. The present patent application provides that different market solutions are applied to a same ATM to access devices, being responsibility of the “MAM Controller” to make coexistence feasible. It is also foreseen that the applied means are compatible with equipment from different manufacturers.

The present patent application provides applying different “Client applications” to a same ATM, as long as all client applications are under the same operating system; there are no restrictions regarding which operating system should be applied.

It is further foreseen the functioning compatibility in ATMs from various manufacturers, which is served by the different possible layers of access to TecBan property devices and Client devices compatibility.

### GLOSSARY

User: herein means anyone accessing equipment, for either operation and maintenance or consultations and financial transactions;

ATM: Automated Teller Machine;

Equipment: herein means Automated Teller Machine (ATM);

Client Application: Application module responsible for providing users with consultations and financial transactions;

MAM Controller: Application orchestrator;

MAM Manager: Operator Module, responsible for equipment operation, configurations, tests, diagnoses, maintenance, and supply;

MAM Agent: Equipment monitoring agent;

Framework: means a support structure defined wherein another software project can be organized and developed. A framework may include support programs, code libraries, script languages and other software to help developing and unite different components of software project.

### Legend of FIG. 1

A—MAM Agent (monitoring)

B—MAM Controller

C—Client Application 1

D—Client Application 2

E—Client Application 3

F—Client Application n

G—MAM Manager (operation)

H—Layer of access to devices

I—Devices' drivers

J—Operating system

K—Devices

L—Pin Pad

M—Monitor

N—Money counter

O—Card reader

P—Receipt printer

Q—Miscellaneous

1. “DEVICE AND METHOD FOR ATM MULTI-APPLICATION”, wherein it provides a companionship solution of property application with client applications from several institutions, wherein monitoring and operation (module Operator) are under responsibility of independent modules, having multiplicity only of client modules; it provides device and method allowing the companionship of “Property Application” with “Client applications” from other Financial Institutions, and provides a model wherein monitoring and operation are under responsibility of a same owner, having multiplicity only from “Client Modules”, i.e., “Property+Other Institutions”; it provides the integration of “Client Modules” from several financial institutions in a same ATM (automatic teller machine); the modules responsible for operation and monitoring the equipment are unique; “MAM Controller” (application orchestrator) is the module responsible for managing and actuating several “Client applications” and “Operator Module” (even though it is foreseen for client applications, other third-party modules can be added, as necessary); in a user's entry, via magnetic card, chip, touch-screen, remote operation via network or any other access interface, “MAM Controller” identifies which application must be actuated among known applications, besides monitoring the completion of each session, and then release the equipment to be used by next users; for “Client applications/Modules” from other Financial Institutions, there will be fixes so that one can actuate them from “Application orchestrator”, it is foreseen that “Client applications” can be connected to market “frameworks”, wherein various “frameworks” are able to share a same ATM; “MAM Manager” (Operator Module) is responsible for the operation of the ATM and, depending on the equipment manufacturer, a test module can be eventually actuated by the manufacturer; “MAM Manager” will offer all functionalities necessary for equipment configuration, tests, diagnoses, maintenance and supply; the “MAM Agent”, will be the only component for ATM monitoring; monitoring will provide MAM Manager with information regarding operations, multiple client modules, with information regarding transactions, and ATM devices; it provides that device access and control managers define the form of accessing and controlling ATM devices, which may vary, depending on the solution used by each “Client Application”; it provides that different market solutions are applied in a same ATM to access devices, being responsibility of the “MAM Controller” to make coexistence feasible; it is foreseen that applied means are compatible with equipment from different manufacturers; it provides applying different “Client applications” in a same ATM, as long as all client applications are under the same operating system; it further provides the functioning compatibility in ATMs from various manufacturers, which is served by the different possible layers of access to applied property devices and Client devices.
